(19) United States
(12) Patent Application Publication
(10) Pub. No.: US 2012/0105762 A1
(43) Pub. Date: May 3, 2012

(54) EDGE-LIT BACKLIGHT MODULE AND LIQUID CRYSTAL DISPLAY

(75) Inventor: Chengwen Que, Shenzhen (CN)

(73) Assignee: SHENZHEN CHINA STAR OPTOELECTRONICS TECHNOLOGY CO., LTD., Shenzhen (CN)

(21) Appl. No.: 13/217,621

(22) Filed: Aug. 25, 2011

(30) Foreign Application Priority Data
Nov. 3, 2010 (CN) 201010532374.X

(51) Int. Cl. G02F 1/13357; F21V 8/00; F21V 23/00

(52) U.S. Cl. 349/60; 349/58; 362/631; 362/612

(57) ABSTRACT

The present invention discloses an edge-lit backlight module and a liquid crystal display, the edge-lit backlight module comprises a back plate, a light guide plate (LGP), a fixing frame and a light emitting device. The fixing frame embraces and fixes the light guide plate on the back plate, a circuit board of the light emitting device is disposed outside the fixing frame, the fixing frame is provided with at least one light incident opening corresponding to at least one light emitting element of the light emitting device. The present invention provides an edge-lit source required by the LGP but insulates most of heat generated by the light emitting element by the light incident opening.

### TECHNICAL FIELD OF THE INVENTION

The present invention relates to an edge-lit backlight module and liquid crystal display (LCD), more particularly, to edge-lit backlight module and LCD having a function of heat insulation.

### BACKGROUND OF THE INVENTION

In the field of liquid crystal display (LCD) panel, a light emitting diode (LED) has superiorities of environment protection and power saving in comparison with a cold cathode fluorescent lamp (CCFL) when being used as a backlight source. Therefore, it is a trend of backlight development that the CCFL will be displaced by the LED. However, a heat dissipation problem of the LED is still a fatal factor influencing the development. Please refer to FIG. 1, which is a side sectional view of a current edge-lit backlight module. An edge-lit backlight module 90 comprises a back plate 91. The back plate heat dissipation construction 91 has sidewalls 911 at both side edges, and a light guide plate (LGP) 92 is carried on the center of the back plate 91. An optical film set 93 is provided on the LGP 92. Further, a mold frame 94 embraces an outer edge of the back plate 91 and fixes the optical film set 93 and the LGP 92 from top to bottom, so as to form the edge-lit backlight module 90. In addition, a liquid crystal panel 80 is optionally provided on the edge-lit backlight module 90. A display outer frame 70 embraces and fixes the liquid crystal panel 80 and the edge-lit backlight module 90. Accordingly, an LCD is assembled.

As shown in FIG. 1, a light emitting device 95 is provided on an inner surface of the sidewall 911 of the back plate 91 of the edge-lit backlight module 90. The light emitting device 95 comprises a circuit board 951 and multiple light emitting components 952 arranged on the circuit board 951. The light emitting elements 952 can be LED light emitting elements, and the direction of the light sources is directed to the LGP 92. The light emitting elements 952 are fixed on the sidewall 911 by screwing with screws or adhering with thermal conductive tape.

However, there still is a problem existing in the current edge-lit backlight module described above. That is, in the current edge-lit backlight module, the light emitting device 95 and the LGP 92 as well as the optical film set 93 are placed in the same chamber. When the light emitting device 95 operates, the temperature will rapidly raise. Locally, the temperature of the LGP 92 and the optical film set 93 will also sharply rise. The thermal conduction performance of the current LGP 92 and optical film set 93 is poor. The heats of the LGP 92 and the optical film set 93 concentrate at an end near the light emitting device 95 obviously, resulting in the temperature difference between the LGP 92 and the optical film set 93 is too significant, and therefore causing an abnormal phenomenon such as the deformation of the LGP 92 and the optical film set 93. Accordingly, the performance quality of the edge-lit backlight module 90 is influenced.

Thus, it is necessary to provide an edge-lit backlight module with heat insulation function to solve the problem existing in the prior art.

### SUMMARY OF THE INVENTION

A primary objective of the present invention is to provide an edge-lit backlight module and liquid crystal display, in which a circuit board of a light emitting device is disposed outside a fixing frame, and the fixing frame is defined with at least one light incident opening corresponding to at least one light emitting element of the light emitting device. Therefore, the light emitting device of the present invention can serve as an edge-lit light source while most of the heat generated by the light emitting device can be insulated.

A secondary objective of the present invention is to provide an edge-lit backlight module and liquid crystal display, in which the distance between the light guide plate and the light emitting device is kept constant by disposing an elastic element at an opposite side of the light guide plate with respect to the light emitting device, so as to provide a stable light source and solve the expansion and contraction problem of the light guide plate.

To achieve the above objectives, the present invention provides an edge-lit backlight module, comprising:

a back plate;

a light guide plate disposed on the back plate;

a fixing frame embracing an outer edge of the back plate, fixing the light guide plate on the back plate; and

a light emitting device comprising a circuit board and at least one light emitting element disposed on the circuit board;

the circuit board of the light emitting device is disposed outside the fixing frame, the fixing frame is provided with at least one light incident opening corresponding to said at least one light emitting element, so that light rays of the light emitting element radiate toward the light guide plate via the light incident opening.

In an embodiment of the present invention, the at least one light incident opening is a closed or opened light incident opening.

In an embodiment of the present invention, the at least one light emitting element is lodged in the at least one light incident opening.

In an embodiment of the present invention, the material of the fixing frame is heat insulating or/and an inner surface of the fixing frame is reflective.

To achieve the above objectives, the present invention further provides a liquid crystal display having an edge-lit backlight module, which comprises: a backlight module, a liquid crystal panel and a display outer frame, the liquid crystal disposed on the backlight module, the display outer frame embracing and fixing the liquid crystal panel and the backlight module, the backlight module comprises:

a back plate;

a light guide plate disposed on the back plate;

a fixing frame embracing an outer edge of the back plate, fixing the light guide plate on the back plate; and

a light emitting device comprising a circuit board and at least one light emitting element disposed on the circuit board;

the circuit board of the light emitting device is disposed outside the fixing frame, the fixing frame is provided with at least one light incident opening corresponding to said at least one light emitting element, so that light rays of the light emitting element radiate toward the light guide plate via the light incident opening.

In an embodiment of the present invention, the circuit board is attached to an inner side of the display outer frame.

In an embodiment of the present invention, the at least one light incident opening is a closed or opened light incident opening.

In an embodiment of the present invention, the at least one light emitting element is lodged or not lodged in the at least one light incident opening.

In an embodiment of the present invention, the material of the fixing frame is heat insulating or/and an inner surface of the fixing frame is reflective.

In an embodiment of the present invention, an elastic element is further provided at an opposite end of the light guide plate with respect to the light emitting device, the elastic element supports between the light guide plate and the fixing frame.

In an embodiment of the present invention, the light emitting element is a light emitting diode.

The present invention ensures the performance quality of the whole edge-lit backlight module by disposing the light emitting device outside the backlight module, in which the light emitting device has the light rays passing through the light incident opening correspondingly provided on the fixing frame to serve as an edge-lit light source required by the light guide plate, while most the heat generated by the light emitting device is insulated from an inner chamber of the backlight module, thus the light guide plate and an optical film set will not be over-heated and so the abnormal phenomenon such as deformation will not occur.

### BRIEF DESCRIPTION OF THE DRAWINGS

FIG. 1 is a partial and sectional side view of a current edge-lit backlight module.

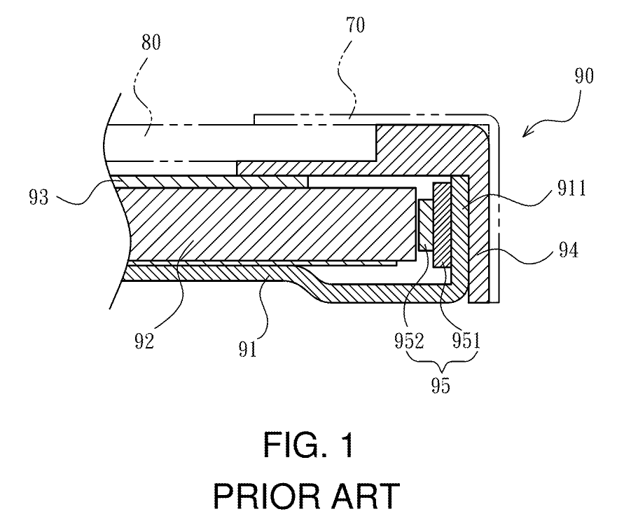

FIG. 2 is a partial and sectional side view of an edge-lit backlight module of a first embodiment of the present invention.

FIG. 3 is a partial and exploded perspective view of the edge-lit backlight module of the first embodiment of the present invention.

FIG. 4 is a partial and assembled perspective view of the edge-lit backlight module of the first embodiment of the present invention.

FIG. 5 is a partial and exploded perspective view of an edge-lit backlight module of a second embodiment of the present invention.

FIG. 6 is a partial and sectional side view of an edge-lit backlight module of a third embodiment of the present invention.

### DETAILED DESCRIPTION OF THE INVENTION

To make the forgoing objectives, features, and advantages more manifest and understandable, preferred embodiments of the present invention will be described in detail in conjunction with the appending drawings as follows:

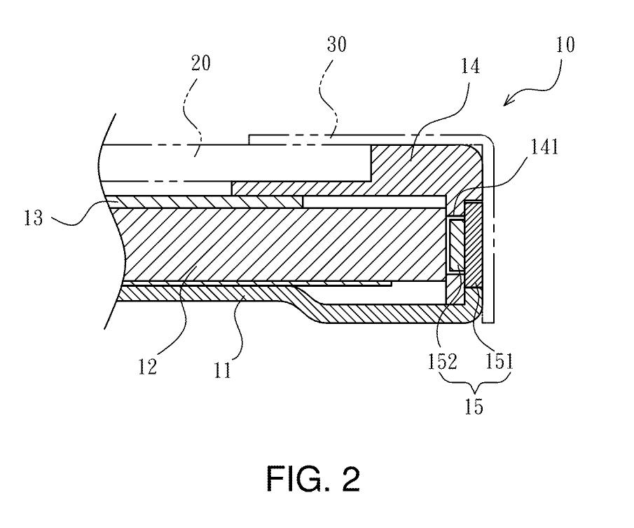

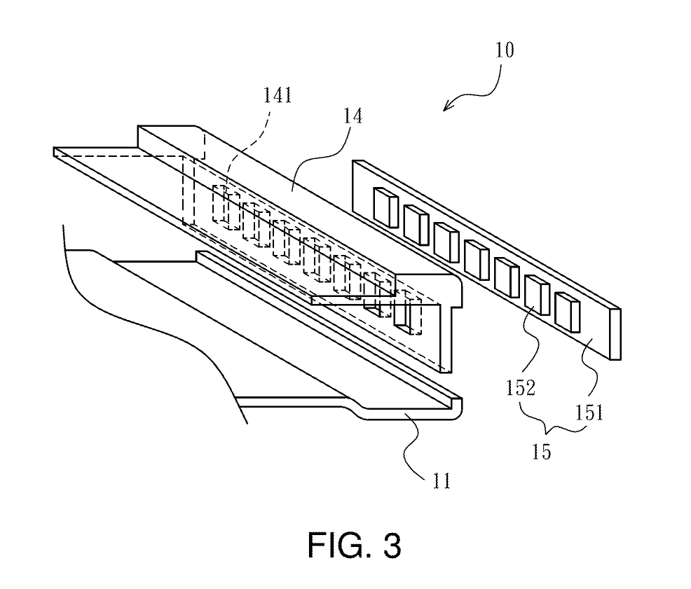

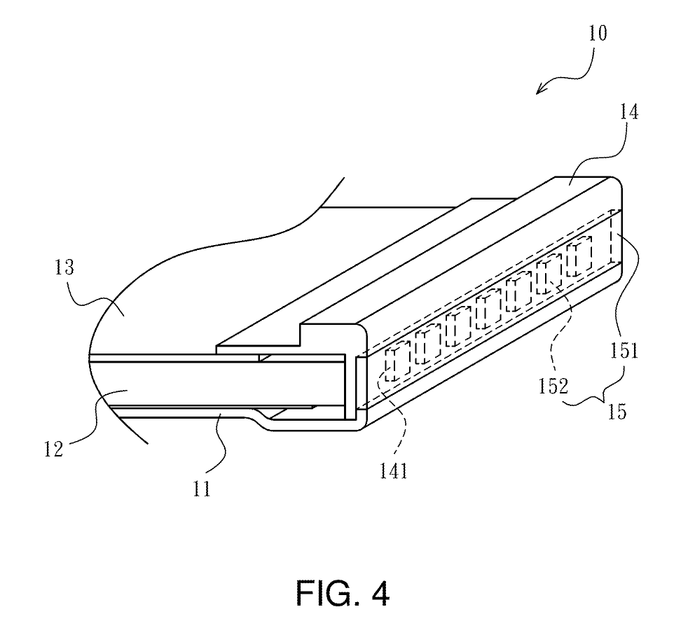

Please refer FIGS. 2 to 4 at the same time, FIG. 2 shows a partial and sectional side view of an edge-lit backlight module of a first embodiment of the present invention; FIG. 3 shows a partial and exploded perspective view of the edge-lit backlight module of the first embodiment of the present invention; and FIG. 4 shows a partial and assembled perspective view of the edge-lit backlight module of the first embodiment of the present invention.

As shown in FIG. 2 to FIG. 4, the edge-lit backlight module 10 comprises
a back plate 11, a light guide plate (LGP) 12, an optical film set 13, a fixing frame 14 and a light emitting device 15. The back plate is a main body substantially shaped as a rectangle; the LGP 12 is disposed on the back plate 11; the optical film set 13 is disposed on the LGP 12; the fixing frame 14 embraces an outer edge of the back plate 11 to fix the optical film set 13 and the LGP 12 on the back plate 11.

Furthermore, the light emitting device 15 comprises a circuit board 151 and at least one light emitting element 152 disposed on the circuit board 151. The circuit board 151 of the light emitting device 15 is disposed outside the fixing frame 14. The fixing frame 14 has at least one light incident opening 141 corresponding to the at least one light emitting element 152. The light emitting element 152 radiates light source toward the LGP 12 via the light incident opening 141.

In addition, as shown in FIG. 2, a liquid crystal panel 20 (indicated by the imaginary line) is further optionally disposed on the edge-lit backlight module 10, and a display outer frame 30 (indicated by the imaginary line) is used to embrace and fix the liquid crystal panel 20 and the edge-lit backlight module 10, and so that a liquid crystal display (LCD) is assembled.

As shown in FIG. 2 to FIG. 4, a light emitting diode (LED) element is usually used as the light emitting element 152 on the light emitting device 15 of the present invention. Under a circumstance that there are multiple light emitting devices 15, the LED elements are arranged in line and disposed on the circuit board 151 of the light emitting device. The light emitting device 15 is usually called an LED light bar. However, the present invention is not limited to the number, outline, type and arrangement of the light emitting elements. Basically, there is a spacing distance between the light emitting elements 152. Therefore, the light incident openings 141 of the fixing frame 14 are designed to correspond to the shape and the spacing distance of the light emitting elements 152.

Further, in the first embodiment of the present invention, the light incident opening 141 is at a close state. The size of the opening is suitable for the light rays of the light emitting element 152 to pass through. There can be several conditions. For example, as shown in FIG. 2, the light emitting element 152 is inwardly lodged in the light incident opening 141 of the fixing frame 14 from outside without protruding from the fixing frame 14. Alternatively, the light emitting element 152 is not lodged in the light incident opening 141, while only the light rays emitted from the light emitting element 152 enter into the light incident opening 141 to irradiate an edge side of the LGP 12.

To sum up, the light emitting device 15 will generate heat during operation. Since the circuit board 151 of the light emitting device 15 is disposed outside the fixing frame 14, most of the heats generated by the circuit board 151 and the light emitting element 152 of the light emitting device 15 can be transferred and insulated outside the fixing frame 14. That is, most of the heat will not enter into an inner chamber of the backlight module 10. Therefore, the LGP 12 and the optical film set 13 inside the backlight module 10 will not be locally subject to too much heat, which might cause the abnormal phenomenon such as deformation to occur to the LGP 12 and the optical film set 13, and thereby ensuring the performance quality of the edge-lit backlight module 10.

Moreover, since the circuit board 151 of the light emitting device 15 is disposed outside the fixing frame 14, disassembling the backlight module 10 is not required when maintaining the light emitting device 15. The light emitting device 15 can be entirely detached from outside, thereby the convenience of maintainance is improved and the risk that the LGP 12 and the optical film set 13 might be polluted or damaged during disassembling the backlight module 10 is effectively prevented. Therefore, the edge-lit backlight module and LCD provides significant improvements in maintainance, assembly and lift of heat dissipation efficiency of the backlight module 10.

Furthermore, the material of the fixing frame 14 is preferably a heat insulating material, especially a favorable heat insulating material such as engineering plastic, so the heat generated by the light emitting device 15 can be insulated outside the inner chamber of the backlight module 10 more effectively. In addition, an inner surface of the fixing frame 14 is preferably reflective, especially having a well-reflective inner surface. In this way, the light rays at edge sides of the LGP 12 can be reflected back into the LGP 12 by this surface, so as to further promote the light emitting performance of the LGP 12.

Moreover, a back side of the circuit board 151 of the light emitting device 15, that is, an outward surface without the light emitting elements 152 disposed, is preferably attached to the inner side of the display outer frame 30. In this way, the heat generated by the light emitting device 15 can be further transferred out through the display outer frame 30, so as to facilitate the heat dissipation of the backlight module 10. Further, a portion of the circuit board 151 contacted with the display outer frame 30 is preferably made of a favorable heat conductive material so as to further lift the whole heat dissipation efficiency of the backlight module 10.

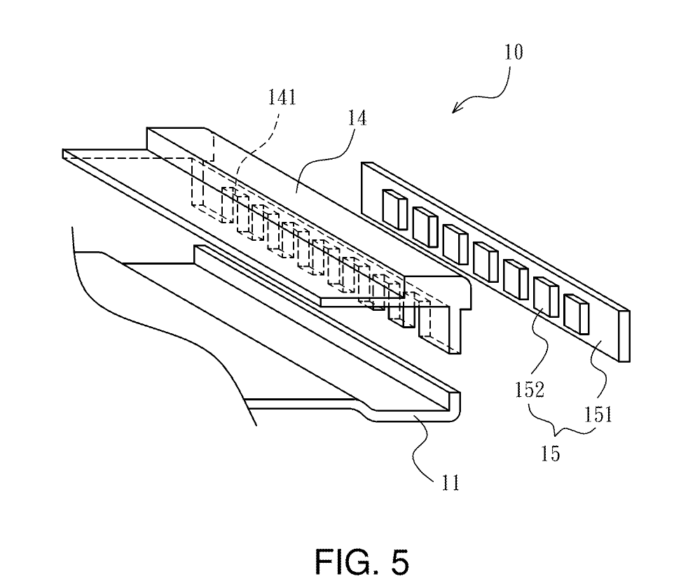

Please refer to FIG. 5, which shows a partial and exploded perspective view of an edge-lit backlight module of a second embodiment of the present invention. The backlight module 10 of the second embodiment of the present invention is similar to the backlight module 10 of the first embodiment of the present invention, and therefore the same reference numbers and terms are used. However, the difference is that: the fixing frame 14 of the backlight module 10 of the second embodiment in accordance with the present invention has an opened light incident opening 141. The opened light incident opening 141 becomes a closed opening through a coordinate design corresponding to an inner bottom surface of the back plate 11, and can also allow the light rays of the light emitting device 15 to pass through while insulate most of the heat generated by the light emitting device 15. By such a design, more flexibility can be attained on manufacturing and assembling the fixing frame 14.

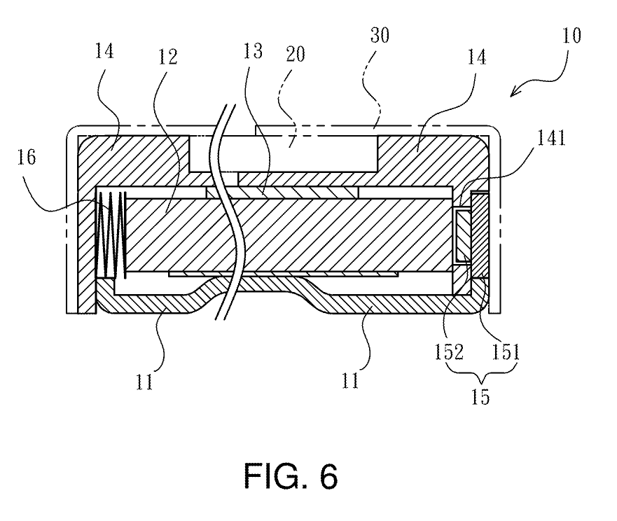

Please refer to FIG. 6, which shows a partial and sectional side view of an edge-lit backlight module of a third embodiment of the present invention. The backlight module 10 of the third embodiment of the present invention is similar to the backlight module 10 of the first embodiment of the present invention, and therefore the same reference numbers and terms are used. However, the difference is that: an elastic element 16 is provided at an opposite end of the LGP 12 of the third embodiment of the present invention with respect to the light emitting device 15 (the left side in the drawing). The elastic element 16 is a spring, for example. However, the elastic element 16 described in the present invention can be made of any elastic material and have any shape. For instance, it can be a rubber piece. The elastic element 16 supports between the LGP 12 and the fixing frame 14, and therefore the end (the right side in the drawing) of the LGP 12 near the light emitting device 15 can be attached against the fixing frame 14 tightly by the elastic action of the elastic element 16. Expansion and contraction phenomenon will occur to the LGP when it is heated. Therefore, the distance between the LGP 12 and the light emitting device 15 can be kept constant by disposing the elastic element 16 at the side of the LGP 12 without light source entering, so as to provide a stable light source and solve the expansion and contraction problem of the LGP 12.

To sum up, in comparison, the current edge-lit backlight module, in which the light emitting device and the optical film set are placed in the same chamber, the local temperature of the optical film set will dramatically raise when the light emitting device operates, causing the optical film set to occur an abnormal phenomenon such as deformation, and thereby influencing the performance quality of the whole backlight module. The present invention ensures the performance quality of the whole edge-lit backlight module 10 by disposing the light emitting device 15 outside the backlight module 10, in which the light emitting device 15 has the light rays passing through the light incident opening 141 correspondingly provided on the fixing frame 14 to serve as an edge-lit light source required by the LGP 12, while most the heat generated by the light emitting device 15 is insulated from the inner chamber of the backlight module 10, thus the LGP 12 and the optical film set 13 will not be over-heated and so the abnormal phenomenon such as deformation will not occur.

The present invention has been disclosed by describing the preferred embodiments, however, the above embodiments are only the examples for implementing the present invention. It must be pointed out that the disclosed embodiments do not limit the scope of the present invention. To the contrary, modifications and equivalent alterations embraced in the spirit and scope of the claims should all be included in the scope of the present invention.

What is claimed is:

1. A liquid crystal display having an edge-lit backlight module comprising: a backlight module, a liquid crystal panel and a display outer frame, the liquid crystal disposed on the backlight module, the display outer frame embracing and fixing the liquid crystal panel and the backlight module, said backlight module comprising:
a back plate;
a light guide plate disposed on the back plate;
a fixing frame embracing an outer edge of the back plate, fixing the light guide plate on the back plate; and
a light emitting device comprising a circuit board and at least one light emitting element disposed on the circuit board;
characterized in that: the circuit board of the light emitting device is disposed outside the fixing frame, and the circuit board is attached to an inner side of the display outer frame, the fixing frame is provided with at least one light incident opening corresponding to said at least one light emitting element, so that light rays of the light emitting element radiate toward the light guide plate via the light incident opening.

2. The liquid crystal display having an edge-lit backlight module as claimed in claim 1, characterized in that: said at least one light incident opening is a closed or opened light incident opening.

3. The liquid crystal display having an edge-lit backlight module as claimed in claim 1, characterized in that: said at least one light emitting element is lodged in said at least one light incident opening.

4. The liquid crystal display having an edge-lit backlight module as claimed in claim 1, characterized in that: material of the fixing frame is heat insulating, or/and an inner surface of the fixing frame is reflective.

5. The liquid crystal display having an edge-lit backlight module as claimed in claim 1, characterized in that: an elastic element is provided at an opposite end of the light guide plate with respect to the light emitting device, said elastic element supports between the light guide plate and the fixing frame.

6. The liquid crystal display having an edge-lit backlight module as claimed in claim 1, characterized in that: the light emitting element is a light emitting diode.

7. A liquid crystal display having an edge-lit backlight module, comprising: a backlight module, a liquid crystal panel and a display outer frame, the liquid crystal disposed on the backlight module, the display outer frame embracing and fixing the liquid crystal panel and the backlight module, said backlight module comprising:
a back plate;
a light guide plate disposed on the back plate;
a fixing frame embracing an outer edge of the back plate, fixing the light guide plate on the back plate; and
a light emitting device comprising a circuit board and at least one light emitting element disposed on the circuit board;
characterized in that: the circuit board of the light emitting device is disposed outside the fixing frame, the fixing frame is provided with at least one light incident opening corresponding to said at least one light emitting element, so that light rays of the light emitting element radiate toward the light guide plate via the light incident opening.

8. The liquid crystal display having an edge-lit backlight module as claimed in claim 7, characterized in that: said at least one light incident opening is a closed or opened light incident opening.

9. The liquid crystal display having an edge-lit backlight module as claimed in claim 7, characterized in that: said at least one light emitting element is lodged in said at least one light incident opening.

10. The liquid crystal display having an edge-lit backlight module as claimed in claim 7, characterized in that: material of the fixing frame is heat insulating, or/and an inner surface of the fixing frame is reflective.

11. The liquid crystal display having an edge-lit backlight module as claimed in claim 7, characterized in that: an elastic element is provided at an opposite end of the light guide plate with respect to the light emitting device, said elastic element supports between the light guide plate and the fixing frame.

12. The liquid crystal display having an edge-lit backlight module as claimed in claim 7, characterized in that: the light emitting element is a light emitting diode.

13. An edge-lit backlight module, comprising:
a back plate;
a light guide plate disposed on the back plate;
a fixing frame embracing an outer edge of the back plate, fixing the light guide plate on the back plate; and
a light emitting device comprising a circuit board and at least one light emitting element disposed on the circuit board;
characterized in that: the circuit board of the light emitting device is disposed outside the fixing frame, the fixing frame is provided with at least one light incident opening corresponding to said at least one light emitting element, so that light rays of the light emitting element radiate toward the light guide plate via the light incident opening.

14. The edge-lit backlight module as claimed in claim 13, characterized in that: said at least one light incident opening is a closed or opened light incident opening.

15. The edge-lit backlight module as claimed in claim 13, characterized in that: said at least one light emitting element is lodged in said at least one light incident opening.

16. The edge-lit backlight module as claimed in claim 13, characterized in that: material of the fixing frame is heat insulating, or/and an inner surface of the fixing frame is reflective.

17. The edge-lit backlight module as claimed in claim 13, characterized in that: the light emitting element is a light emitting diode.
